(19) United States
(12) Patent Application Publication
(10) Pub. No.: US 2025/0147263 A1
(43) Pub. Date: May 8, 2025

(54) ACTUATOR AND OPTICAL UNIT

(71) Applicant: NIDEC INSTRUMENTS CORPORATION, Nagano (JP)

(72) Inventor: Shogo KASAHARA, Nagano (JP)

(21) Appl. No.: 18/777,547

(22) Filed: Jul. 19, 2024

(30) Foreign Application Priority Data
Jul. 20, 2023 (JP) 2023-118341

(51) Int. Cl. G02B 7/02; H01F 7/08

(52) U.S. Cl. CPC G02B 7/02; H01F 7/081

(57) ABSTRACT

An actuator includes a movable body connected with a lens unit and a sensor unit, a fixed body holding the movable body in a turnable state with an intersecting direction intersecting an optical axis direction as a turning axis, and a gimbal mechanism. The gimbal mechanism includes a turnable member having a base plate in a frame shape into which the movable body is inserted and a plurality of leg parts extended from the base plate along the optical axis direction, and support parts engaged with the leg parts and supporting the leg parts in a turnable state. The leg parts have a first leg part which is protruded from the base plate to an inner side and then extended along the optical axis direction, and a second leg part which is protruded from the base plate to an outer side and then extended along the optical axis direction.

### CROSS REFERENCE TO RELATED APPLICATION

The present invention claims priority under 35 U.S.C. § 119 to Japanese Application No. 2023-118341 filed Jul. 20, 2023, the entire content of which is incorporated herein by reference.

### TECHNICAL FIELD

At least an embodiment of the present invention may relate to an actuator and an optical unit.

### BACKGROUND

Conventionally, various optical units have been used. In these optical units, an optical unit has been known which includes a lens unit, a sensor unit and an actuator capable of connecting with the lens unit and the sensor unit. For example, in Japanese Patent Laid-Open No. 2017-21332 (Patent Literature 1), an optical unit is disclosed which includes a movable body having an imaging module provided with a lens and an imaging element, and a fixed body which holds the movable body in a turnable state with a direction intersecting an optical axis direction as a turning axis.

In a conventional optical unit which includes a lens unit, a sensor unit and an actuator capable of connecting with the sensor unit and the lens unit, a large lens unit may be required to be connected with the actuator depending on uses. In a case that a large lens unit is required to be connected with the actuator, a gimbal mechanism which holds a movable body in a turnable state with respect to a fixed body is necessary to increase the rigidity. In order to increase rigidity of the gimbal mechanism, it is conceivable that leg parts which structure the gimbal mechanism are extended in directions intersecting an optical axis direction and the leg parts are pressed against support parts which are attached to a movable body and a fixed body. However, according to this structure, a size of the gimbal mechanism is increased in a direction intersecting the optical axis direction and thus, a size of the actuator is easily increased and, as a result, the optical unit is easily enlarged.

### SUMMARY

According to at least an embodiment of the present invention, there may be provided an actuator capable of connecting with a sensor unit and a lens unit. The actuator includes a movable body which is to be connected with the lens unit and the sensor unit, a fixed body which holds the movable body in a turnable state with at least one of intersecting directions intersecting an optical axis direction as a turning axis, and a gimbal mechanism which includes a turnable member which has a base plate in a frame shape into which the movable body is inserted and a plurality of leg parts which are extended from the base plate along the optical axis direction, and support parts which are engaged with the leg parts and support the leg parts in a turnable state. The turnable member is, as the leg parts, provided with a first leg part which is protruded from the base plate in an inner side direction and then extended along the optical axis direction, and a second leg part which is protruded from the base plate in an outer side direction and then extended along the optical axis direction.

### Effects of the Invention

According to at least an embodiment of the present invention, a size of the actuator capable of connecting with the lens unit and the sensor unit can be reduced.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a perspective view showing an optical unit in accordance with an embodiment of the present invention.

FIG. 2 is an exploded perspective view showing a lens unit, a sensor unit and an actuator of the optical unit shown in FIG. 1.

FIG. 3 is a front view showing the actuator of the optical unit in FIG. 1.

FIG. 4 is a front view showing a movable body of the actuator of the optical unit in FIG. 1.

FIG. 5 is a front view showing a fixed body of the actuator of the optical unit in FIG. 1.

FIG. 6 is a perspective view showing the movable body and a gimbal mechanism of the actuator in the optical unit shown in FIG. 1.

FIG. 7 is a cross-sectional view showing the movable body and the gimbal mechanism of the actuator in the optical unit shown in FIG. 1 which is cut in the “A-A” line in FIG. 3.

FIG. 8 is a cross-sectional view showing the fixed body, the movable body and the gimbal mechanism of the actuator in the optical unit shown in FIG. 1 which is cut in the “B-B” line in FIG. 3.

FIG. 9 is a cross-sectional view showing the actuator of the optical unit in FIG. 1 which is viewed from a front face side.

### DETAILED DESCRIPTION

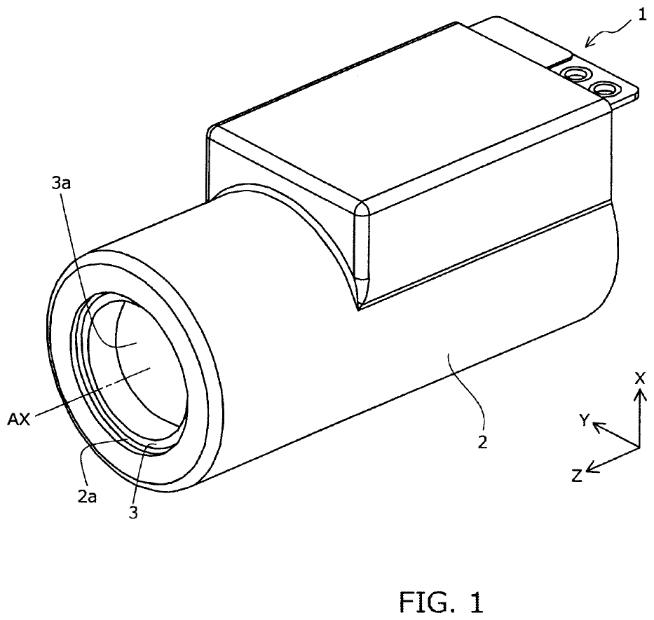

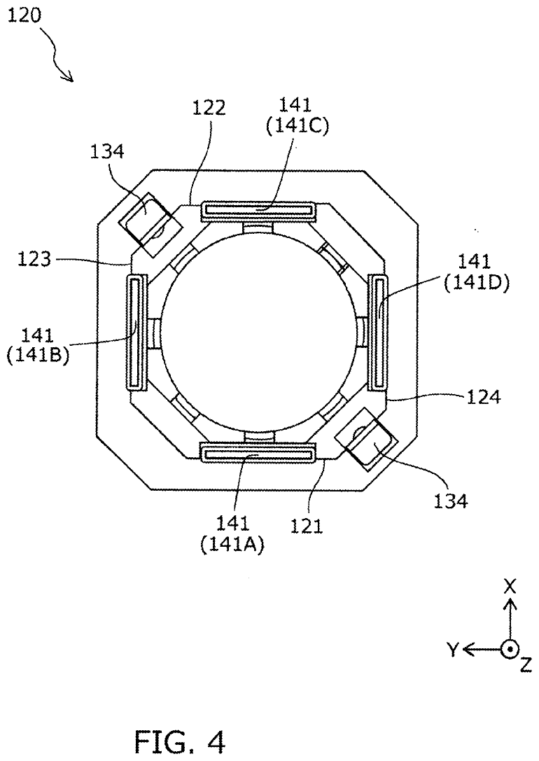

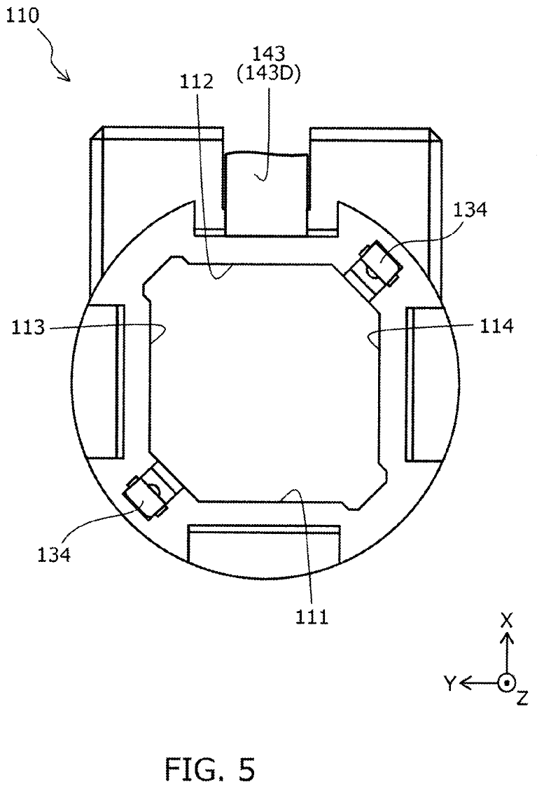

An optical unit 1 in accordance with an embodiment of the present invention will be described below with reference to FIGS. 1 through 9. In each figure, a “Z”-axis direction is an optical axis direction extending in an optical axis “AX”, an “X”-axis direction is a direction intersecting the optical axis “AX”, i.e., an axial direction of yawing, and a “Y”-axis direction is a direction intersecting the optical axis “AX”, i.e., an axial direction of pitching. Further, in the “Z”-axis directions, a “+Z” direction which is a direction where the arrow is directed is an object side direction, and a “−Z” direction which is a reverse direction to the direction where the arrow is directed is an anti-object side direction which is an opposite side to the object side.

### Entire Structure of Optical Unit

First, an entire structure of an optical unit 1 in accordance with an embodiment of the present invention will be described below. The optical unit 1 in this embodiment includes a housing 2 as shown in FIG. 1. As shown in FIG. 1, a lens unit 3 having a lens 3a is provided in the housing 2.

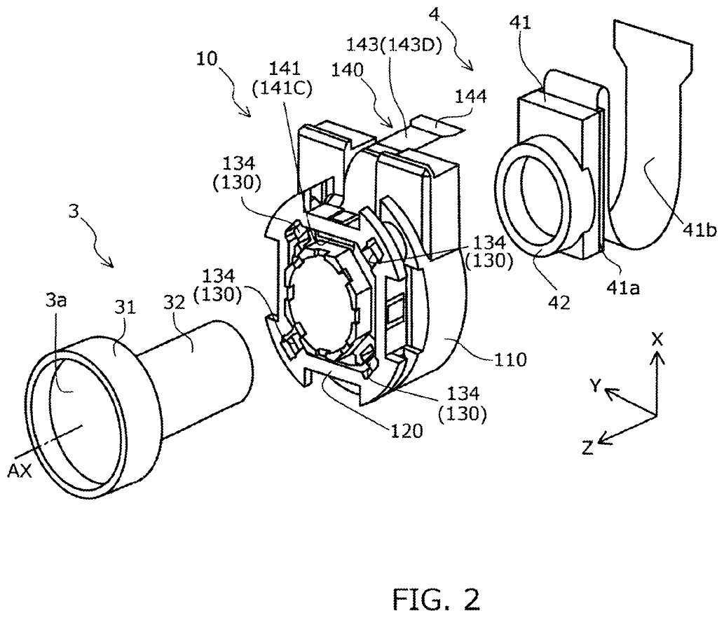

Further, the housing 2 is provided with an actuator 10 and a sensor unit 4 in addition to the lens unit 3 as shown in FIG. 2. As shown in FIG. 1, the housing 2 is provided with a hole part 2a, and the lens unit 3 is disposed in the housing 2 so that the lens 3a is viewed through the hole part 2a when viewed in an optical axis direction. The actuator 10 is structured so as to connect with the sensor unit 4 and the lens unit 3 and capable of displacing the lens unit 3 in the housing 2.

### Lens Unit

The lens unit 3 in this embodiment is connected with the actuator 10 and, in addition, also connected with the sensor unit 4 in a connected state with the actuator 10. As shown in FIG. 2, the lens unit 3 in this embodiment is provided with a lens attaching portion 31 to which the lens 3a is attached, and a first connecting portion 32 whose diameter is smaller than the lens attaching portion 31. The first connecting portion 32 is connected with the actuator 10 and also connected with the sensor unit 4.

### Sensor Unit

The sensor unit 4 in this embodiment includes a large rectangular portion 41 to which an imaging element 41a is attached and a second connecting portion 42 with which the first connecting portion 32 is connected. In this embodiment, the first connecting portion 32 is formed in a cylindrical tubular shape, and the second connecting portion 42 is also formed in a cylindrical tubular shape. Further, in a state that the first connecting portion 32 is connected with the actuator 10, the first connecting portion 32 and the second connecting portion 42 are connected with each other so that an outer peripheral part of the first connecting portion 32 is fitted to an inner peripheral part of the second connecting portion 42. The imaging element 41a is connected with a flexible board 41b.

### Actuator

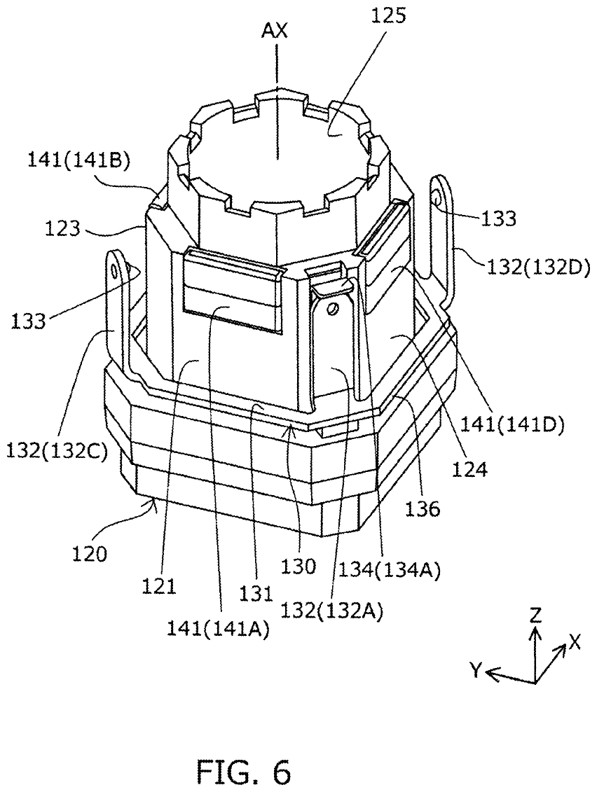

As shown in FIG. 2 and the like, the actuator 10 in this embodiment includes a fixed body 110 which is fixed to the housing 2 and a movable body 120 which is connected with the lens unit 3 and the sensor unit 4 and is displaceable with respect to the fixed body 110. Further, the actuator 10 in this embodiment includes a gimbal mechanism 130 which is connected with the fixed body 110 and the movable body 120 as shown in FIGS. 6 through 8 and the like.

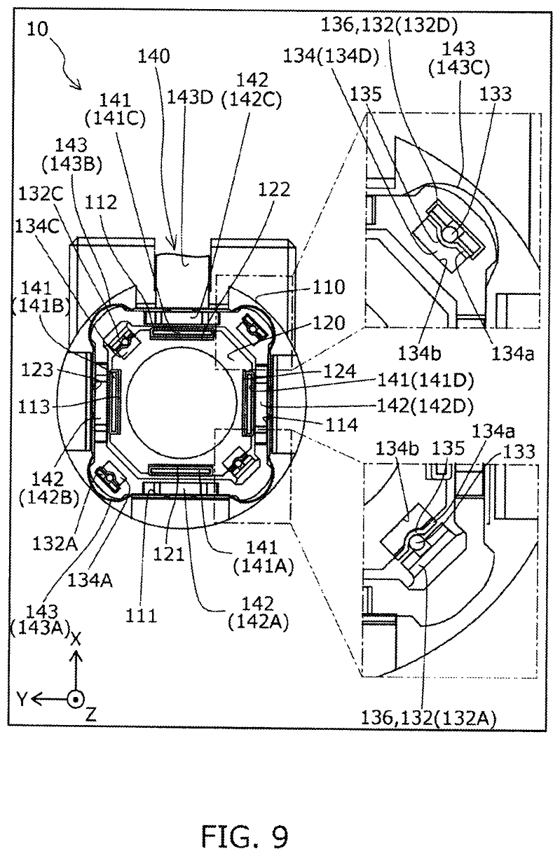

The fixed body 110 holds the movable body 120 by the gimbal mechanism 130 in a turnable state with at least one of intersecting directions intersecting the optical axis direction such as the “X”-axis direction and the “Y”-axis direction as a turning axis. In addition, the actuator 10 in this embodiment includes, as shown in FIG. 9 and the like, a drive mechanism 140 which is provided with magnets 141, coils 142 and a flexible board 143 and is structured to generate a drive force for turning the movable body 120 with respect to the fixed body 110. In this embodiment, the flexible board 143 is provided with a flexible board 143A, a flexible board 143B and a flexible board 143C each of which connects the coils 142 with each other, and a flexible board 143D connected with a terminal 144 as shown in FIG. 2.

### Movable Body

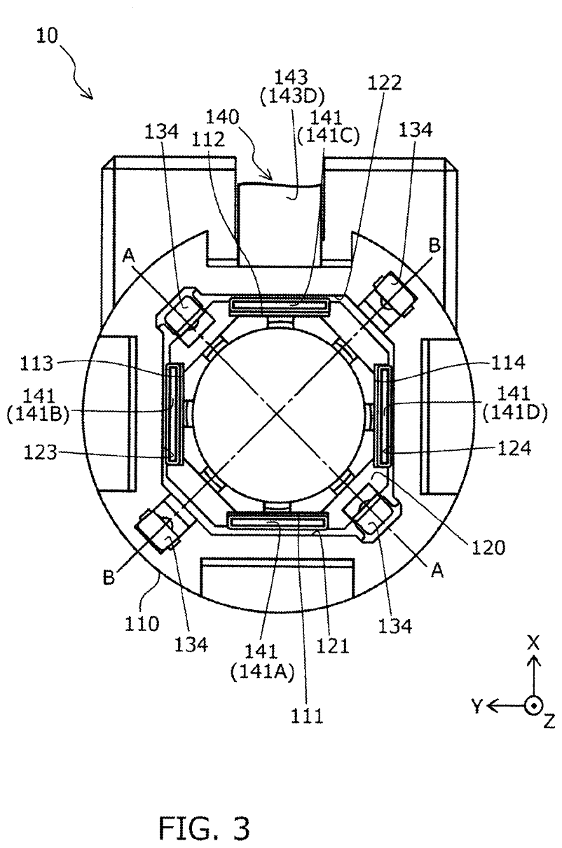

The movable body 120 is, as shown in FIGS. 3, 4, 6 and 9, provided with a first face 121 and a second face 122, which are parallel with the optical axis direction (“Z”-axis direction) and face each other, and a third face 123 and a fourth face 124 which are parallel with the optical axis direction and perpendicular to the first face 121 and the second face 122 and face each other. The first face 121 is provided with a magnet 141A as the magnet 141, the second face 122 is provided with a magnet 141C as the magnet 141, the third face 123 is provided with a magnet 141B as the magnet 141, and the fourth face 124 is provided with a magnet 141D as the magnet 141.

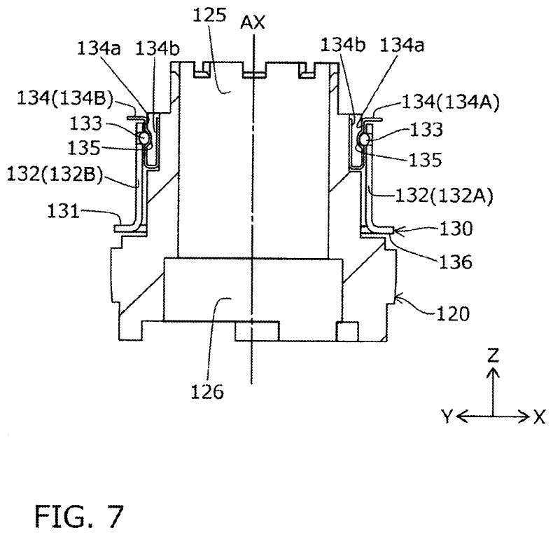

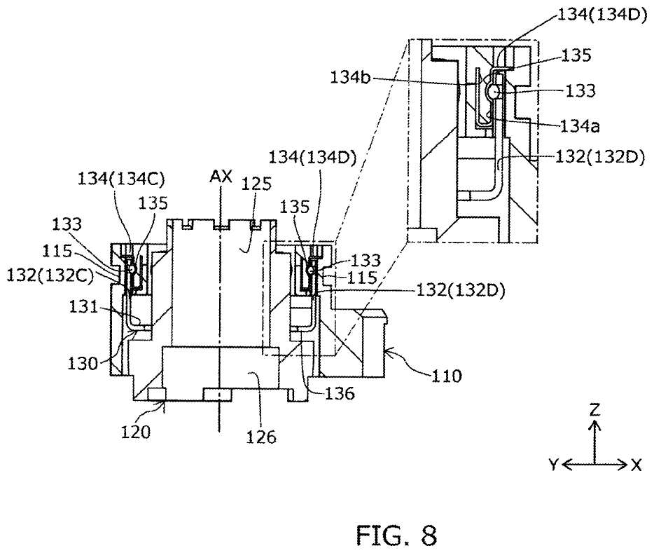

Further, the movable body 120 is, as shown in FIGS. 7 and 8, provided with a first insertion port 125 into which the first connecting portion 32 is capable of being inserted in a first direction (direction from the “+Z” direction side toward the “−Z” direction side) in the optical axis direction, and a second insertion port 126 into which the second connecting portion 42 is capable of being inserted in a second direction (direction from the “−Z” direction side toward the “+Z” direction side) which is opposite to the first direction. When the movable body 120 connected with the lens unit 3 and the sensor unit 4 is displaced with respect to the fixed body 110, the lens unit 3 and the sensor unit 4 are also displaced with respect to the fixed body 110.

### Fixed Body

The fixed body 110 is, as shown in FIGS. 3, 5 and 9, provided with a first opposing face 111 which faces the first face 121, a second opposing face 112 which faces the second face 122, a third opposing face 113 which faces the third face 123, and a fourth opposing face 114 which faces the fourth face 124. As shown in FIGS. 3, 8 and 9, the movable body 120 is disposed in an area surrounded by the first opposing face 111, the second opposing face 112, the third opposing face 113 and the fourth opposing face 114 of the fixed body 110. Further, as shown in FIG. 9, as the coils 142, the coil 142A is provided on the first opposing face 111, the coil 142C is provided on the second opposing face 112, the coil 142B is provided on the third opposing face 113, and the coil 142D is provided on the fourth opposing face 114.

Further, as shown in FIG. 8, the fixed body 110 is provided with a flexible board arrangement groove 115 which is recessed toward an inner side when viewed in the optical axis direction for arranging the flexible board 143 along the fixed body 110. When the flexible board arrangement groove 115 is provided, in a case that the movable body 120 is displaced with respect to the fixed body 110, a situation is suppressed that the flexible board 143 is moved to interfere with the movable body 120.

### Gimbal Mechanism

The gimbal mechanism 130 includes, as shown in FIGS. 6 through 9, a turnable member 136 provided with a base plate 131 formed in a frame shape into which the movable body 120 is inserted and four leg parts 132 which are extended from the base plate 131 along the optical axis direction, and support parts 134 each of which is engaged with the leg part 132 and supports the leg part 132 in a turnable state. In this embodiment, as the leg parts 132, the turnable member 136 is, as shown in FIGS. 6 and 7, provided with first leg parts 132A and 132B which are protruded from the base plate 131 to an inner side when viewed in the optical axis direction and then extended along the optical axis direction and, as shown in FIGS. 6 and 8, provided with second leg parts 132C and 132D which are protruded from the base plate 131 to an outer side and then extended along the optical axis direction. Further, as the support parts 134, as shown in FIG. 7, the gimbal mechanism 130 includes first support parts 134A and 134B which are fixed to the movable body 120 and support the first leg parts 132A and 132B in a turnable state and, as shown in FIG. 8, second support parts 134C and 134D which are fixed to the fixed body 110 and support the second leg parts 132C and 132D in a turnable state.

In other words, the support part 134 is provided at two positions in the fixed body 110 on an extension line of a first straight line (“B-B” straight line in FIG. 3) which is extended from a position between the first face 121 and the third face 123 to a position between the second face 122 and the fourth face 124 when viewed in the optical axis direction, and at two positions in the movable body 120 on an extension line of a second straight line (“A-A” straight line in FIG. 3) which is extended from a position between the first face 121 and the fourth face 124 to a position between the second face 122 and the third face 123 when viewed in the optical axis direction. Further, as shown in FIGS. 7 and 8, each of the support parts 134 is similarly structured to each other and is formed in a “U”-shape which is structured of an engaging part 134a formed with a recessed part 135 engaging with a protruded part 133 provided in each leg part 132, and a fixed part 134b fixed to the fixed body 110 or the movable body 120, and the engaging part 134a and the fixed part 134b face each other. The gimbal mechanism 130 supports the turnable member 136 by a spring force of the support part 134 in the “U”-shape and turnably holds the movable body 120 with respect to the fixed body 110. In other words, the gimbal mechanism 130 in this embodiment is structured of the turnable member 136 having high rigidity which is provided with the base plate 131 and the leg parts 132 and the support parts 134 formed in a “U”-shape which is easily resiliently bent.

### Drive Mechanism

The drive mechanism 140 in this embodiment includes a magnet 141A and a coil 142A provided at a position facing the magnet 141A, a magnet 141B and a coil 142B provided at a position facing the magnet 141B, a magnet 141C and a coil 142C provided at a position facing the magnet 141C, and a magnet 141D and a coil 142D provided at a position facing the magnet 141D. In this embodiment, the magnet 141A, the magnet 141B, the magnet 141C and the magnet 141D are similarly structured to each other, and the coil 142A, the coil 142B, the coil 142C and the coil 142D are similarly structured to each other. In this structure, the magnet 141A and the coil 142A, and the magnet 141C and the coil 142C structure a pitching axis swing mechanism. Further, the magnet 141B and the coil 142B, and the magnet 141D and the coil 142D structure a yawing axis swing mechanism.

Next, the actuator 10 of the optical unit 1 in this embodiment will be described below. The actuator 10 in this embodiment is, as described above, capable of connecting with the lens unit 3 and the sensor unit 4. Further, the actuator 10 in this embodiment includes the movable body 120 which is connected with the lens unit 3 and the sensor unit 4, and the fixed body 110 which holds the movable body 120 in a turnable state with at least one of intersecting directions intersecting the optical axis direction as a turning axis. In addition, the actuator 10 in this embodiment includes the gimbal mechanism 130 which is provided with the turnable member 136 having the frame-shaped base plate 131 into which the movable body 120 is inserted and a plurality of the leg parts 132 which are extended from the base plate 131 along the optical axis direction, and the support parts 134 which are engaged with the leg parts 132 and support the leg parts 132 in a turnable state.

In this embodiment, the turnable member 136 is, as the leg parts 132, provided with the first leg parts 132A and 132B, which are protruded from the base plate 131 in an inner side direction when viewed in the optical axis direction and then extended along the optical axis direction, and the second leg parts 132C and 132D which are protruded from the base plate 131 in an outer side direction and then extended along the optical axis direction. In other words, in a structure that the movable body 120 is disposed on an inner side with respect to the fixed body 110 when viewed in the optical axis direction, the gimbal mechanism 130 is structured so that the movable body 120 is supported by the leg parts 132 which are protruded in an inner side direction when viewed in the optical axis direction and then extended along the optical axis direction, and the leg parts 132 which are protruded in an outer side direction when viewed in the optical axis direction and then extended along the optical axis direction are supported by the fixed body 110. According to this structure, a size of the gimbal mechanism 130 can be reduced and, as a result, the actuator 10 capable of connecting with the sensor unit 4 and the lens unit 3 and the optical unit 1 can be reduced in size.

In the above-mentioned structure, even in a case that the leg parts 132 structuring the gimbal mechanism 130 are only extended in the optical axis direction and the leg parts 132 are pressed by the support parts 134 attached to the movable body 120 and the fixed body 110, a size of the optical unit 1 can be reduced in comparison with a structure that the leg parts 132 structuring the gimbal mechanism 130 are extended in a direction intersecting the optical axis direction and the leg parts 132 are pressed against the support parts 134 attached to the movable body 120 and the fixed body 110. However, when structured so that the movable body 120 is supported by the leg parts 132 which are protruded in an inner side direction when viewed in the optical axis direction and then extended along the optical axis direction, and the fixed body 110 is supported by the leg parts 132 which are protruded in an outer side direction when viewed in the optical axis direction and then extended along the optical axis direction, a size of the gimbal mechanism 130 can be further reduced.

Further, as described above, in the actuator 10 in this embodiment, the gimbal mechanism 130 is, as the support parts 134, provided with the first support parts 134A and 134B, which are fixed to the movable body 120 and support the first leg parts 132A and 132B in a turnable state, and the second support parts 134C and 134D which are fixed to the fixed body 110 and support the second leg parts 132C and 132D in a turnable state. According to this structure, the movable body 120 can be turnably supported with respect to the fixed body 110 with both of a yawing axial direction and a pitching axial direction as turning axes.

Further, as described above, in the actuator 10 in this embodiment, the support part 134 is formed in a “U”-shape which is structured of the engaging part 134a engaged with the leg part 132 and the fixing part 134b fixed to the fixed body 110 or the movable body 120, and the engaging part 134a and the fixing part 134b face each other. Further, the gimbal mechanism 130 supports the turnable member 136 by a spring force of the support part 134 in the “U”-shape and turnably holds the movable body 120 with respect to the fixed body 110. According to this structure, rigidity of the turnable member 136 can be increased and, for example, even in a case that the lens unit 3 having a large heavy lens 3a or the like is attached to the movable body 120, the movable body 120 can be preferably displaced with respect to the fixed body 110.

Further, in the actuator 10 in this embodiment, the support parts 134 are arranged at a position in the optical axis direction so as to overlap with a gravity center position of the movable body 120 in a state that the movable body 120 is connected with the lens unit 3 and the sensor unit 4. According to this structure, when the movable body 120 is displaced with respect to the fixed body 110, swinging is hardly occurred and the movable body 120 can be preferably displaced with respect to the fixed body 110.

Embodiments of the present invention may be structured as follows.

(1) An actuator which is capable of connecting with a sensor unit and a lens unit, the actuator including:
a movable body which is to be connected with the lens unit and the sensor unit,
a fixed body which holds the movable body in a turnable state with at least one of intersecting directions intersecting an optical axis direction as a turning axis, and
a gimbal mechanism which includes:
   a turnable member which has a frame-shaped base plate into which the movable body is inserted, and a plurality of leg parts which are extended from the base plate along the optical axis direction; and
   support parts which are engaged with the leg parts and support the leg parts in a turnable state.
      The turnable member is, as the leg parts, provided with a first leg part which is protruded from the base plate in an inner side direction and then extended along the optical axis direction, and a second leg part which is protruded from the base plate in an outer side direction and then extended along the optical axis direction.

(2) The actuator described in the above-mentioned structure (1), where the gimbal mechanism includes, as the support parts, a first support part which is fixed to the movable body and supports the first leg part in a turnable state, and a second support part which is fixed to the fixed body and supports the second leg part in a turnable state.

(3) The actuator described in the above-mentioned structure (1) or (2), where the support part is formed in a “U”-shape which is structured of an engaging part engaged with the leg part and a fixing part fixed to the fixed body or the movable body, and the engaging part and the fixing part face each other, and the gimbal mechanism supports the turnable member by a spring force of the support part in the “U”-shape and turnably holds the movable body with respect to the fixed body.

(4) The actuator described in one of the above-mentioned structures (1) through (3), where the support part is arranged in the optical axis direction at a gravity center position of the movable body in a state that the movable body is connected with the lens unit and the sensor unit.

(5) An optical unit including the actuator described in one of the above-mentioned structures (1) through (4), the lens unit and the sensor unit.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An actuator capable of connecting with a sensor unit and a lens unit, the actuator comprising:
a movable body which is to be connected with the lens unit and the sensor unit;
a fixed body which holds the movable body in a turnable state with at least one of intersecting directions intersecting an optical axis direction as a turning axis; and
a gimbal mechanism which comprises:
a turnable member which has a base plate in a frame shape into which the movable body is inserted and a plurality of leg parts which are extended from the base plate along the optical axis direction; and
support parts which are engaged with the leg parts and support the leg parts in a turnable state;
wherein the turnable member comprises, as the leg parts, a first leg part which is protruded from the base plate in an inner side direction and then extended along the optical axis direction, and a second leg part which is protruded from the base plate in an outer side direction and then extended along the optical axis direction.

2. The actuator according to claim 1, wherein the gimbal mechanism comprises, as the support parts, a first support part which is fixed to the movable body and supports the first leg part in a turnable state, and a second support part which is fixed to the fixed body and supports the second leg part in a turnable state.

3. The actuator according to claim 2, wherein
the support part is formed in a “U”-shape which is structured of an engaging part engaged with the leg part and a fixing part fixed to the fixed body or the movable body, and the engaging part and the fixing part face each other, and
the gimbal mechanism supports the turnable member by a spring force of the support part in the “U”-shape and turnably holds the movable body with respect to the fixed body.

4. The actuator according to claim 2, wherein the support part is arranged in the optical axis direction at a gravity center position of the movable body in a state that the movable body is connected with the lens unit and the sensor unit.

5. The actuator according to claim 1, wherein
the support part is formed in a “U”-shape which is structured of an engaging part engaged with the leg part and a fixing part fixed to the fixed body or the movable body, and the engaging part and the fixing part face each other, and
the gimbal mechanism supports the turnable member by a spring force of the support part in the “U”-shape and turnably holds the movable body with respect to the fixed body.

6. The actuator according to claim 1, wherein the support part is arranged in the optical axis direction at a gravity center position of the movable body in a state that the movable body is connected with the lens unit and the sensor unit.

7. An optical unit comprising:
the actuator defined in claim 1;
the lens unit; and
the sensor unit.
